(19) United States
(12) Patent Application Publication
(10) Pub. No.: US 2004/0203381 A1
(43) Pub. Date: Oct. 14, 2004

(54) Method and apparatus for data transfer

(76) Inventors: Janet E. Cahn, Arlington Heights, IL (US); Steven J. Nowlan, South Barrington, IL (US); David Noskowicz, Mundelein, IL (US)

Correspondence Address: MOTOROLA INC, 600 NORTH US HIGHWAY 45, ROOM AS437, LIBERTYVILLE, IL, 60048-5343, US

(21) Appl. No.: 10/334,813

(22) Filed: Dec. 31, 2002

(51) Int. Cl. H04B 5/00; H04Q 7/20

(52) U.S. Cl. 455/41.2; 455/517; 455/70

(57) ABSTRACT

A method and apparatus for ad hoc addressing and group creation for wireless devices is described. A wireless communication device that has a sensor for sensing the contact or proximity of another wireless communication device forms a communication link with the second wireless communication device. The contact or close proximity of the two devices operates to identify the two devices for which a link will be established. This provides easy addressing of the desired device, and security as the user must initiate physically contacting or bring the device in very close proximity to the other device. Once the link is established data can be transferred between the two devices. In the simplest embodiment, the two devices are touched together and personal contact information is automatically exchanged. If a plurality of devices are in close proximity or touched together, an ad hoc network can be formed between all the devices. The network would be established for only as long as needed. A group list, called an electronic contact group is formed for the immediate establishment of the network or saved for later use.

### BACKGROUND OF THE INVENTION

The present invention pertains to electronic devices, and more particularly to transferring data from one communication device to other electronic devices triggered by the proximity of the two devices.

Wireless communication devices are used to communicate with other wireless devices or other communication devices by either voice or data transmissions. A link is established between two devices by identifying or addressing the device intended to be communicated with. Currently, in order for one device to communicate with another device, the recipient device's identification information must be entered into the user's device such that the intended recipient device can be properly addressed. It may be a phone number, device ID, domain name, or internet address, for example, that is entered, or it may be other information, which, depending on the amount of information, can take extended time to enter.

Information cannot be shared between devices or groups of devices efficiently because of the complexity and time necessary to configure and set up the information that is to be shared. A fundamental problem is the need to provide the capability for ad hoc addressing to wireless devices, and in such a way that it occurs quickly, and is activated and de-activated in an intuitive and natural manner. Currently, as discussed, a sender needs to know the address of the receiving device before sending a message. If this information is not in the sender's address database, the sender must enter it by hand on a tiny keyboard or keypad; this is typically awkward and time-consuming. This problem is multiplied if a user wishes to join, create or add to a buddy list, mailing list, chat group, call group or activity group. An activity group includes groups that have a common interest or relation to one another. For example a gaming group is a group of individuals playing games with each other or playing a group game. In a work environment, individuals in a meeting would be an activity group. Currently, each address of each member of the group must be entered by hand on each device. Each user of each device must then collect the addresses into one group by hand. This again, is awkward, time-consuming and inefficient.

The various aspects, features and advantages of the present invention become more fully apparent to those having ordinary skill in the art upon careful consideration of the following Detailed Description of the Invention with the accompanying drawings described below.

### BRIEF DESCRIPTION OF THE DRAWINGS

FIG. 1 is an exemplary block diagram of a wireless communication device of the invention;

FIG. 2 is an exemplary view showing two wireless communication device physically contacting one another in accordance with the invention.

FIG. 3 is an exemplary view of two wireless communication devices in close proximity in accordance with the present invention;

FIG. 4 is an exemplary cross section of a micro-switch in a wireless communication device in accordance with the present invention;

FIG. 5 is an exemplary view of a Hall Effect sensor of the invention;

FIG. 6 is an exemplary view of a reed switch of the present invention;

FIG. 7 is an exemplary view of four contact locations in accordance with the invention;

FIG. 8 is an exemplary flow chart of an ad hoc network protocol of the invention;

FIG. 9 is an exemplary view of two devices transferring information in accordance with the invention;

FIG. 10 is an exemplary flow chart of the exchange of information in accordance with the invention; and

FIG. 11 is an exemplary flow chart of the creation of an electronic community group in accordance with the invention.

### DETAILED DESCRIPTION OF THE INVENTION

As wireless devices become more ubiquitous and common in every day life, using the devices as a communication tool requires ease of use as well as increased functionality. Exchanging information between devices, and ultimately, users, should be seamless and even exciting, giving the user a better experience. The transfer of data between wireless communication devices has been well established, but ease of use has always been an inhibitor to optimized communication. The ability to create a community of users has emerged and has begun to encompass the wireless communication device as it did with the internet. Chat groups and Buddy lists are a few examples of a community personalization. The user personalizes a list that is representative of a community with which that user is associated. A user can have multiple personalized communities. For example, a user may have a list of five individuals with whom the individual plays games. Another example is a group of people coming together to form a search party and desiring to be in electronic and wireless contact for at least the duration of the search. With the wireless communication device as an extension of the internet, new requirements have evolved which not only allow community personalization but also create new experiences and novel features specific to wireless communication and community personalization.

The ability to create an electronic community should be easy and simple, providing the user a useful and enjoyable experience. Having to use many keystrokes to input addresses that are not conducive to current wireless technology, inhibits quick and simple data transfer between devices. In the exemplary embodiment of the invention, a user simply touches one device to another and data transfer is initiated. The touching of the first device to the second device identifies which devices will be exchanging data and establishes a link between the devices in order to further facilitate the transfer of desired information.

The touching of the two devices will initiate both specific data transfer and subsequent actions regarding the specific data or simply establishing a connection via a communication link between the two devices. The physical touching of the devices replaces the need to input addresses required to establish the link between the two devices. In one exemplary embodiment, the contact of the two devices creates an entry in a list or database storing the same or similar information. In another embodiment the database stores the personal community for that specific device or user. In another embodiment the device storing a database, once updated in response to touching a device whose information is not already in the database, sends the new updated database to other devices already listed or stored in the database.

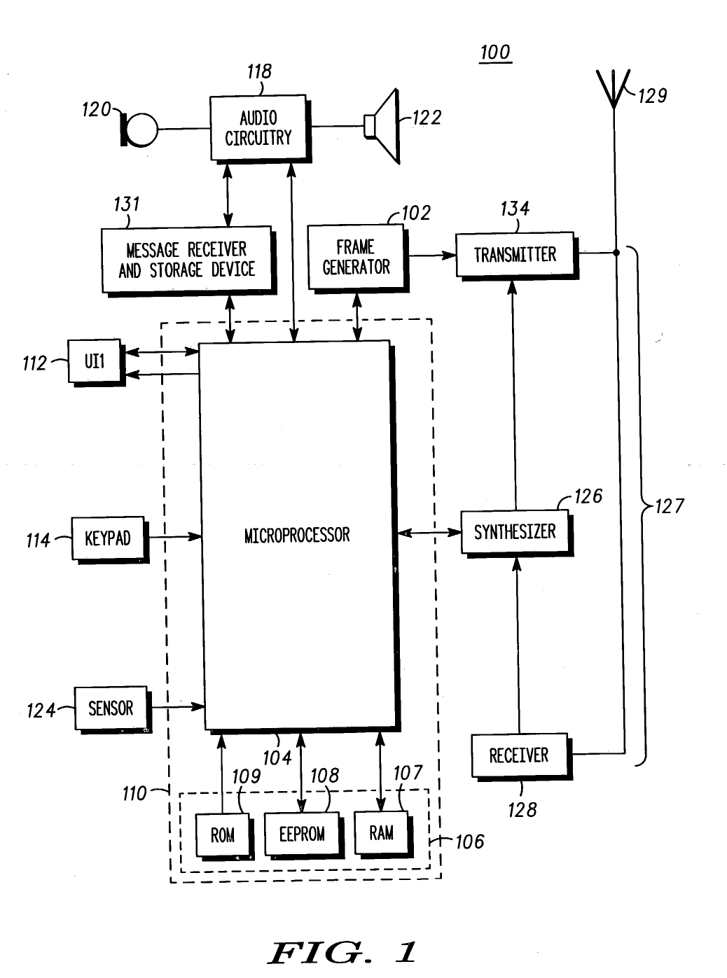

Turning to FIG. 1, a block diagram of a wireless communication device in accordance with the preferred embodiment of the invention is shown. This device is a cellular radiotelephone incorporating the present invention. In the preferred embodiment a frame generator ASIC 102, such as a CMOS ASIC available from Motorola, Inc. and a microprocessor 104, such as a 68HC11 microprocessor also available from Motorola, Inc., combine to generate the necessary communication protocol for operating in a cellular system. Microprocessor 104 uses memory 106 comprising RAM 107, EEPROM 108, and ROM 109, preferably consolidated in one package 110, to execute the steps necessary to generate the protocol and to perform other functions for the wireless communication device, such as writing to a display 112, accepting information from a keypad 114, or controlling a frequency synthesizer 126 and DSP 116. The memory may also include a SIM card 132. ASIC 102 processes audio transformed by audio circuitry 118 from a microphone 120 and to a speaker 122. A sensor 124 is coupled to microprocessor 104. Sensor 124 is for sensing a second wireless communication device. The sensor may sense contact with the second wireless communication device or very close proximity therewith.

FIG. 1 also shows the transceiver 127 comprising receiver circuitry 128 that is capable of receiving RF signals from at least one bandwidth and optionally more bandwidths, as is required for operation of a multiple mode communication device. The receiver 128 may comprise a first receiver and a second receiver, or one receiver capable of receiving in two or more bandwidths. The receiver depending on the mode of operation may be attuned to receive AMPS, GSM, CDMA, UMTS, WCDMA, Bluetooth, WLAN, such as 802.11 communication signals for example. At least one of the receivers may be capable of very low power transmissions for the transmission of link establishment messages and cookie transfer to wireless local area networks. Transmitter circuitry 134, capable of transmitting RF signals in at least one bandwidth in accordance with the operation modes described above. The transmitter may also include a first transmitter 138 and second transmitter 140 to transmit on two different bandwidths or one transmitter that is capable of transmitting on at least two bands. The first bandwidth or set of bandwidths is for communication with a communication system such as a cellular service provider. The second bandwidth or set of bandwidths is for point-to-point communication between two devices or a device and a WLAN.

A housing 142, holds the transceiver 127 made up of the receiver 128 and the transmitter circuitry 134, the microprocessor 104, the sensor 124, and the memory 106. In memory 106 an ad hoc networking algorithm 144 and a database 146 are stored. The sensor 124 is coupled to the microprocessor 104 and upon sensing a second wireless communication device causes microprocessor 104 to execute the ad hoc link establishment algorithm 144.

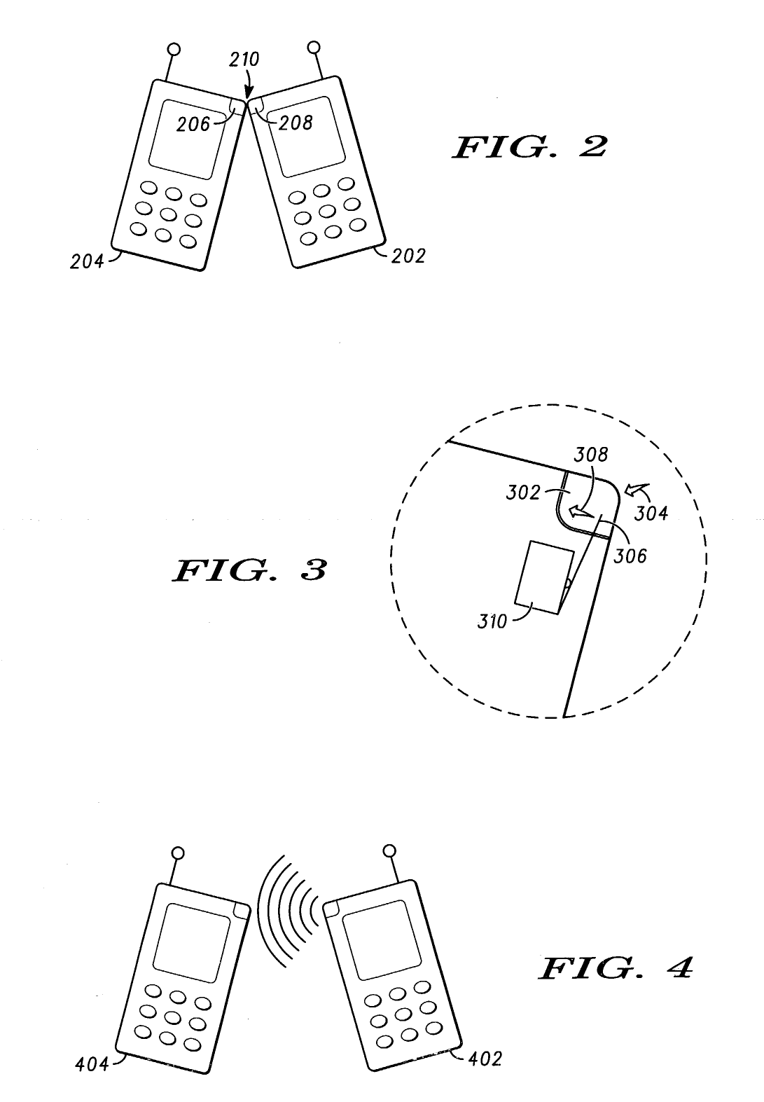

Sensing another wireless communication device can be accomplished in many ways. In one exemplary embodiment, the wireless communication device senses another device in close proximity. In another exemplary embodiment, physical contact of the two devices alerts each device to the presence of the other. In this exemplary embodiment, illustrated in FIG. 2, coupling a metal, metalized, conductive, or conductive polymer surface portion of each device capable of establishing an electrical connection between the two devices. In one exemplary embodiment, illustrated in FIG. 3, a micro-switch 310 on each device can initiate the link establishment sequence in another exemplary embodiment. The micro-switch could be a button or the switch could be situated in the device and covered by a resilient member 302 such as rubber, or the like, to hide and protect the switch. The area, or resilient member would be marked as a contact point, indicating the location on each device as to where to touch them together and close the respective switches. As the resilient member is depressed 304, the movement causes the switch arm 306 to close 308 activating or closing the connection in the switch 310. One skilled in the art is aware that there are a multitude of switches and combinations thereof available. In the exemplary embodiment, a handheld portable electronic device, the switch needs to be small and robust, as it will be subjected to the harsh user environment.

Sensing close proximity can be achieved with a magnetic field sensing switch such as a reed switch or a Hall Effect switch. In this embodiment, illustrated in FIG. 4, one device has a magnetic field generating apparatus 402 while the other device has a reed or Hall Effect switch 404. The switch 404 closes when the magnetic field of the magnetic field generating apparatus 402 is strong enough to activate the switch 404. This generally occurs when the magnetic field is very close (i.e. within centimeters). One of ordinary skill in the art of reed and Hall Effect switch will appreciate that the sensing of proximity is dependent upon the separation distance and the magnetic field strength. This can be controlled through reasonable experimentation to adjust the activation of the switch with the desired separation distance. This will achieve a virtual contact sensing of another device, as the devices may touch together, they may not necessarily do so in order for the sensing to occur. Because the devices may touch in this embodiment, a resilient member of the housing portion for each device may be present. This will protect the housing as the contact of the devices may eventually wear the finish or even break the housing material, generally a plastic. The contact of the two devices however will generate more wear and tear in the contact area.

In one embodiment, the use of proximity sensing of device presence allows multiple devices in close proximity to network together and share information. The close proximity of multiple devices having an “electronic community group list” (ECG) setting enabled would trigger the devices to form an ad hoc network for a finite amount of time with members of the group, during which contact information is exchanged and then compiled into a single new list on each device. This is still possible with physical contact sensing. However, each device desiring to join the “electronic community” would have to touch at least one other device to create the ECG.

Another method of sensing device presence takes advantage of the fact that wireless communication devices are frequently transmitting whether in use by the user or in contact with a base station to maintain a link. In this embodiment, the radio frequency (RF) transmissions can be detected by other devices, even if the device is not the intended recipient of the RF transmission. Depending on the strength, or frequency of the transmissions, sensing the RF transmissions can be used to trigger a link establishment procedure between the two devices. Because this sensing method has the capability to detect RF transmitting devices that, in addition to the intended target device, are considerably further away than the immediate proximity, another step in the process is required to prevent unwanted link establishment accidentally. In this case, the device may have to be put into a mode or a button activated by each device, to initiate the link establishment sequence or process.

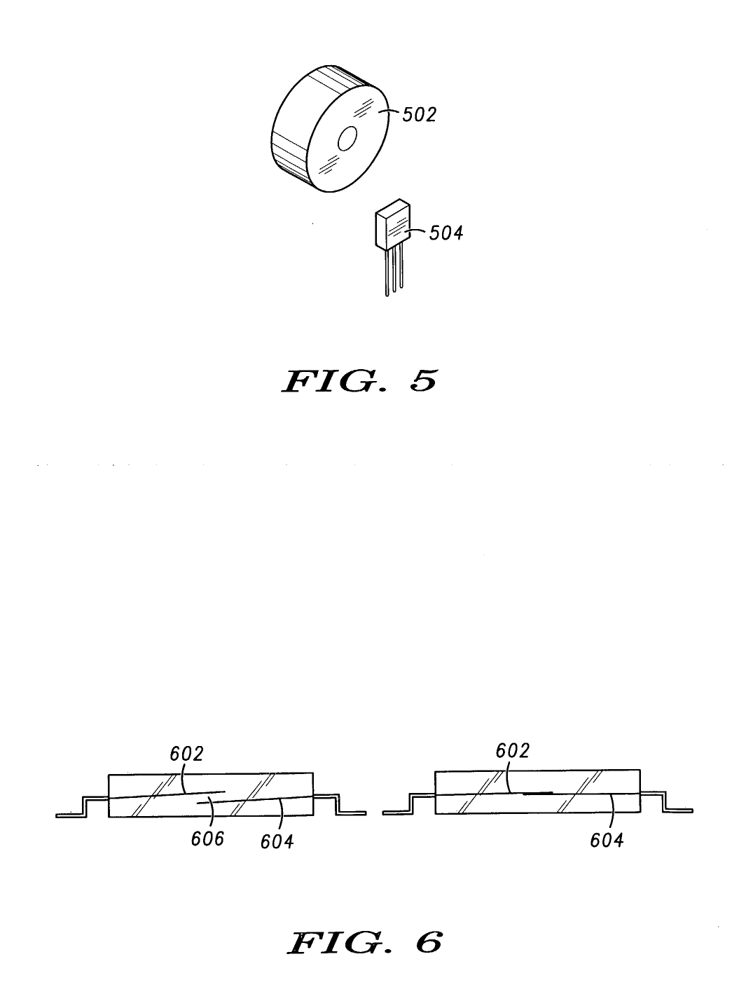

FIGS. 5-6 show various embodiments of the sensor 124 for sensing a magnetic field. FIG. 4 shows a first sensor embodiment, wherein the position sensor comprises a magnet 502 and a Hall Effect sensor 504. The magnet 502 is preferably affixed to an end of the connector element 903, and the Hall Effect sensor 504 is affixed to or embedded in a fixed element 909. The magnet 502 may be comprised of multiple magnetic north and south poles, and may be comprised of multiple magnets or magnetic poles of different strengths and orientations.

The Hall Effect sensor 504 generates an electrical signal when in a magnetic field. The corresponding position sensor circuit board 1035 may use this electrical signal to determine a relative position. FIG. 6 illustrates a reed switch 600. The reed switch 600 has two metallic leads or reeds, a first reed 602, and a second reed 604, which are in parallel planes separated by a small air gap 606. When the two metallic leads are placed in a magnetic field, generated by a magnet 608, at least one of the magnetized lead pulls toward the other lead and closes the circuit.

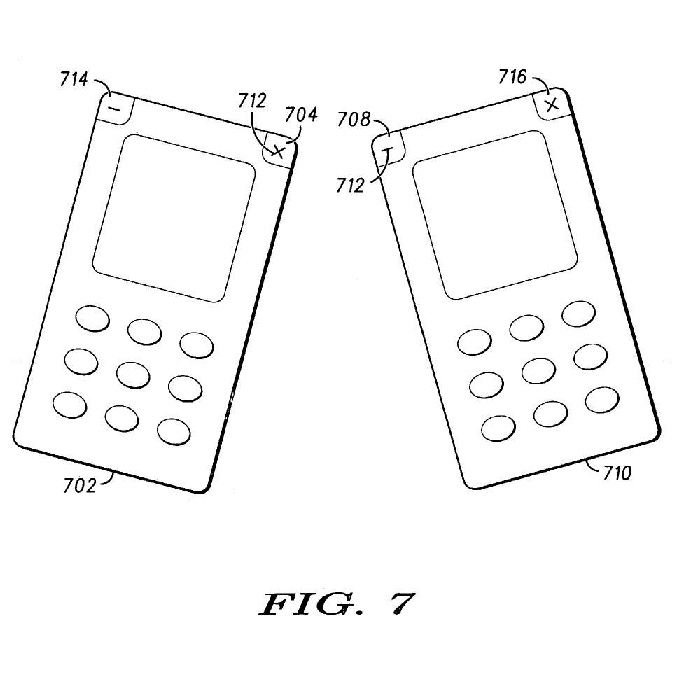

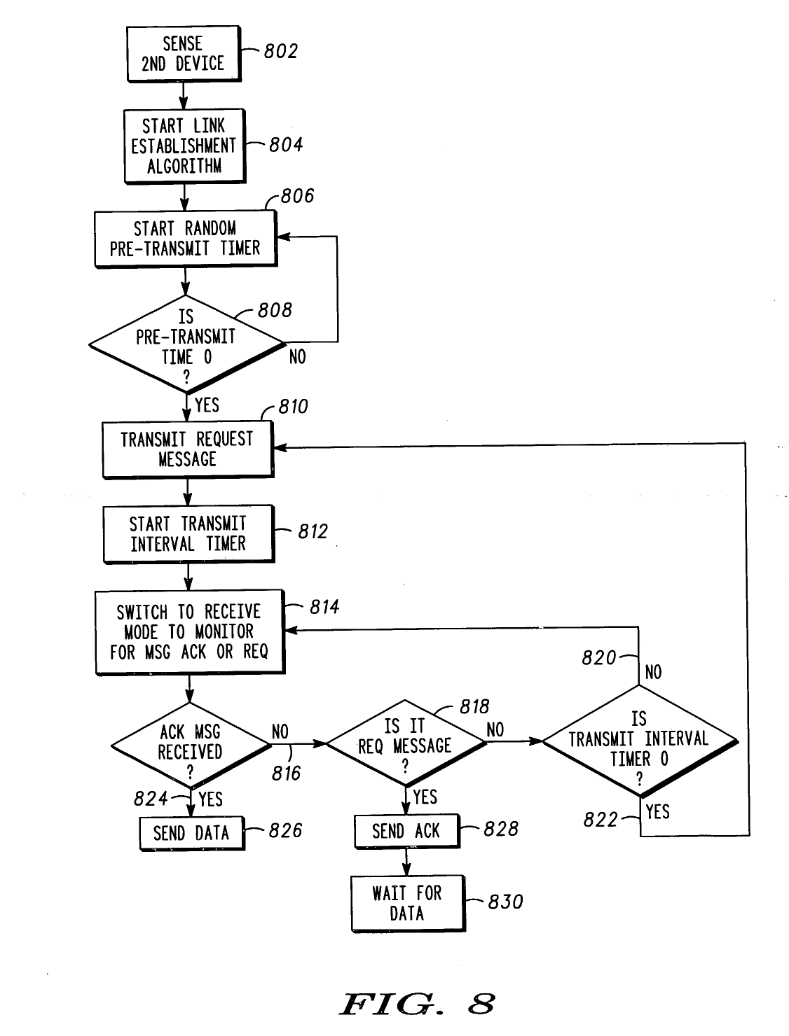

In the exemplary embodiment having a sensor for sensing a magnetic field, one device has at least a magnet at a first defined location 704 on the first housing of the first device 702, and the second device 710 has a reed switch or a Hall Effect sensor 504, in a second defined location on the second housing of the second device as illustrated in FIG. 7. In this embodiment, the first device 702 has a first defined location 704, which as a first indicia 706 indicating where to touch, or bring into proximity a second defined location 708 of the second device 710. At the first defined location 704 is a reed switch or a Hall Effect sensor (not shown), inside the housing of the first device 702. The second define location 708 has a second indicia 712 that is reciprocal to the first indicia 706 of the first device 702. A magnet is located at the second defined location 708 to activate the reed switch or Hall Effect sensor at the first defined location 704. The first device has a magnet at a third defined location 714 that is similar to the second define location 708 on the second device 710. The second device 710 has a reed switch or Hall Effect sensor at a fourth defined location 716, which is reciprocal to the first defined location 704 of the first device 702. Each device has both the magnet and the magnetic field sensor allowing any device to couple with another.

The event of sensing the presence or physical contact of a second wireless communication device initiates a link establishment sequence. This is accomplished in an ad hoc or impromptu fashion, as neither the first device nor the second device is an established master, or slave, between the two devices. This hierarchal relationship is generally required to establish the communication link, however since both devices operate autonomously and independently, an ad hoc process for determining who plays the role of the “master” device, thereby controlling communications between the devices. A “master” will control the flow of information between the two devices following a predetermined protocol to allow for efficient and common command execution. This is generally called a master-slave relationship and is common in networking protocols. In the present case, the exemplary embodiment creates an ad hoc network, initiated by the presence or contact of the two devices. The event of sensing or physical contact, takes the place of entering or selecting an address of the desired target device. In the present embodiment, the act of bringing the devices together indicates to each device which device is the target device and the establishment of a link therebetween. This link can be achieved by point-to-point transmissions or over a network. The point-to-point method would utilize very low power transmissions between the two devices.

In one embodiment, once the event of sensing another device occurs, both devices begin transmitting, at random times and intervals, a message on a predetermined frequency or set of frequencies. This message is a “are you there” message, which is an inquiry or request message to the other device for an acknowledgment. When the respective device is not sending a request message, the device is listening (i.e. the receiver is monitoring a frequency or set of frequencies for identifiable messages) for a request message from the other device. Because each device is transmitting the request message at random times and listening in-between transmissions, at some point in time, one device will be in receive mode and the other in transmit mode, and the receiver will hear the request message. Receiving the request message will trigger a response by the receiving device. The receiving device will transmit an acknowledgement to the first or requesting device. In this embodiment, the requesting device takes on the role of the master and controls the communication link from that point on.

This embodiment is illustrated in the exemplary flow chart in FIG. 8. First, the presence or physical contact of a second device 710 is detected 802, by a first device 702. Next, each device begins a link establishment algorithm 804 and start the random pre-transmit timer 806. The algorithm 804 may wait a random pre-transmit time 806 and when the pre-transmit timer reaches zero 808, transmit a first request message 810. The random pre-transmit time 806 will cause the transmission of a request message by each device to be staggered. As soon as the first device transmits the request message, a second random timer begins 812. At the same time, the first device 702 goes into receive mode 814 to monitor for a request message or acknowledgement message from the second device 710. If the first device has not received an acknowledgement message 816 nor a request message 818, and the transmit interval timer has not reached zero 820, then the first device continues to monitor for a message. If the random transmit interval timer reaches zero 822, before an acknowledgment or request message have been received, then the first device 702 will transmit another or second request message 808. If the first device 702 does receive an acknowledgment 824, a link between the two devices has been established and data can be sent 826. If a request message has been received instead, the first device will transmit an acknowledge message and then wait for more data from the second device. This is just one embodiment and as one of ordinary skill in the art in networking or medium access control (MAC) will recognize, there are other equally effective methods of establishing a communication in an ad hoc fashion for the purposes of the present invention.

There are multiple methods of forming ad hoc and or mesh networks known to those of ordinary skill in the art. These include, for example, several draft proposals for ad hoc network protocols including: The Zone Routing Protocol (ZRP) for Ad Hoc Networks, Ad Hoc On Demand Distance Vector (AODV) Routing, The Dynamic Source Routing Protocol for Mobile Ad Hoc Networks, Topology Broadcast based on Reverse-Path Forwarding (TBRPF), Landmark Routing Protocol (LANMAR) for Large Scale Ad Hoc Networks, Fisheye State Routing Protocol (FSR) for Ad Hoc Networks, The Interzone Routing Protocol (IERP) for Ad Hoc Networks, The Intrazone Routing Protocol (IARP) for Ad Hoc Networks, or The Bordercast Resolution Protocol (BRP) for Ad Hoc Networks.

In the present invention, once the link between at least two proximal devices is established, information can be transferred between the devices. In one embodiment, the temporal link is established between the at least two devices until one of several events occurs: a link timer in one devices times out, the user terminates the link, the devices are separated by a distance greater than a predetermined distance or out of range of any proximal sensing of the devices or another wireless local area network.

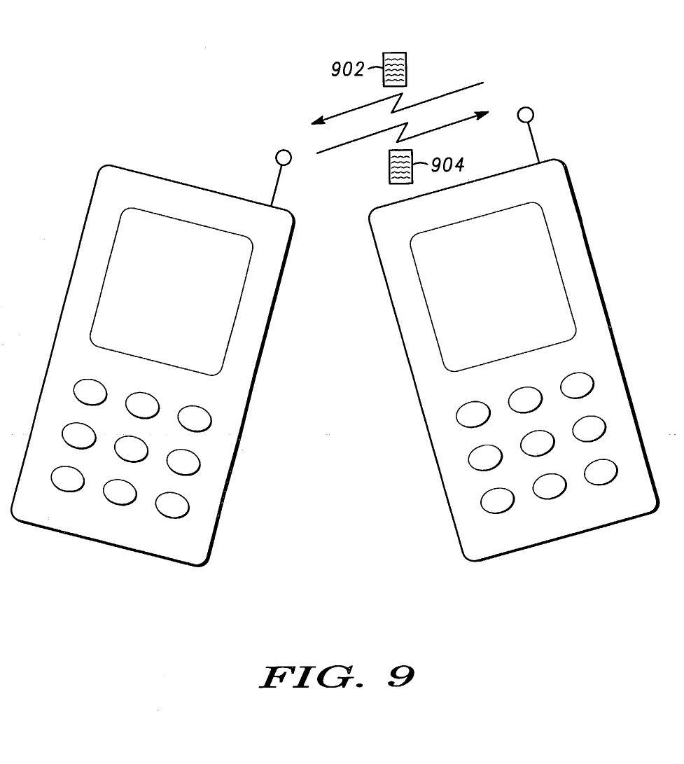

In one embodiment, sensing between two devices only, initiates the exchange of personal data or contact information between the two devices. For example, two people meet and want to share each other's phone number or some information on each other's device. Instead of entering the data manually, the two users simply touch the devices together, establishing the link as discussed above, and the information is automatically shared. FIG. 9 illustrates two devices exchanging contact information 902, 904 that will be stored in the phonebook on each individual device. The contact information 902 904 could also be stored in a buddy list, or a list of contacts for instant messaging purposes. In one embodiment, the devices are brought together either physically touching or in very close proximity to establish the link between the two devices and the devices owners contact information is automatically exchanged. In another embodiment the device must be switched to a mode to activate the transfer up on bringing the devices together. Each device could be switched to the mode or a button held down on the device as the two devices are brought together. In yet another embodiment, the respective users select information they wish to transfer upon touching of the devices. When the devises are touched, the selected information transfers. These are examples of information exchange solely between two devices.

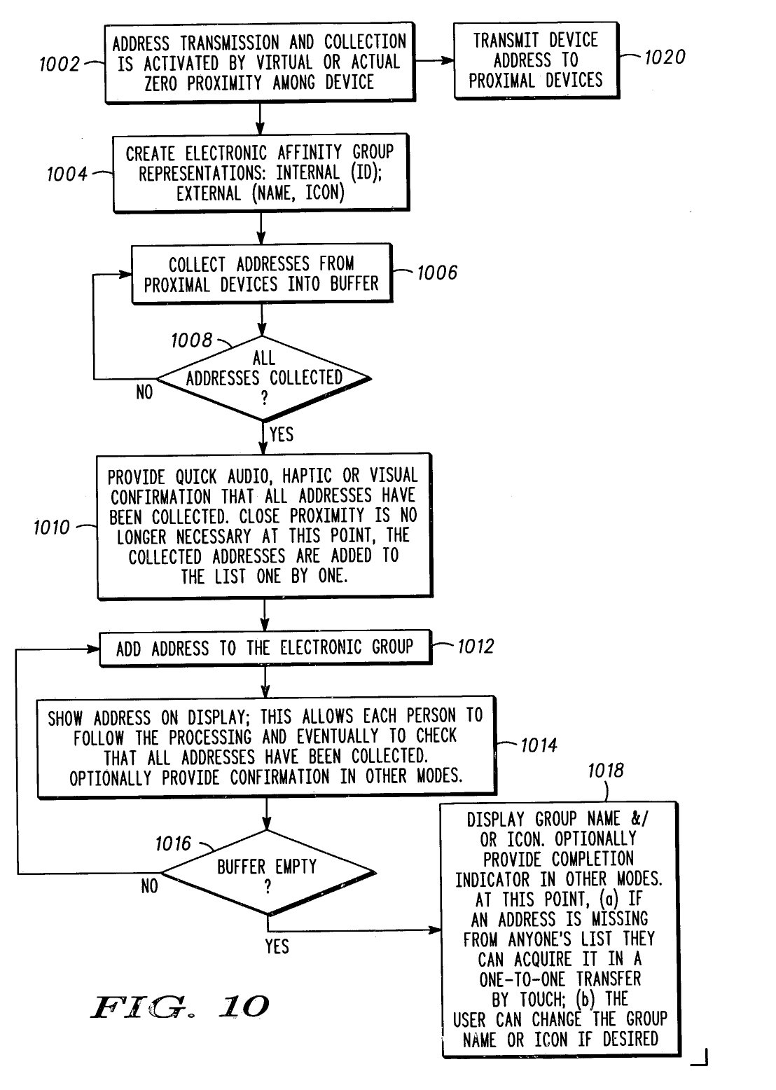

The contact or close proximity of a plurality of devices may cause links to establish with all the devices are information to be circulated thereto. In this embodiment, an electronic community group (ECG) is created though the physical contact or proximity of at least two devices. This may also be referred to as an “electronic affinity group” EAG. FIG. 10 Illustrates a flow chart for creating a new electronic community group. An ECG is a collection of addressing information stored in electronic form. This collection of information allows a sender or caller to send information or voice communications to a group of people by sending one message in various modes (voice, text, image, etc.). Examples include a mailing list or chat group made up of e-mail and SMS addresses, or a call group made up of phone numbers. This may also include a continuous link between the members of a meeting wherein information is distributed and displayed at each users device, such as presentation slides, meeting agenda, or notes for example. After the link is established 1002, each device will start a sequence to create the ECG 1004, and the addresses are collected into the devices buffer 1008. Once all addresses are added 1008, indicated by the user confirming completion of the address collection or a timer, timing out after there has been a lull in address collection or there are no more devices in proximal range. The device may provide feedback, visual audio, or haptic for example, to alert the user that the information collection cycle has been completed 1010. Next, the addresses are added to the ECG 1012. This can be automatic or the user can be queried as to which ECG to add the addresses to or start a new one. Once the list is completed, the list is displayed on the screen for visual verification of each address 1014. In parallel to these steps, the device will transmit its address to the other proximal devices.

To ensure that all the correct devices have been included in the ECG, two things can occur. Each device, upon determination that all addresses have been collected, sends the ECG that it has created to the other devices. The lists will be compared and any discrepancies corrected and verified. If a new member to the ECG is added at a later time, then a new, complete or updated list is sent to all the devices again by the device that added the new member.

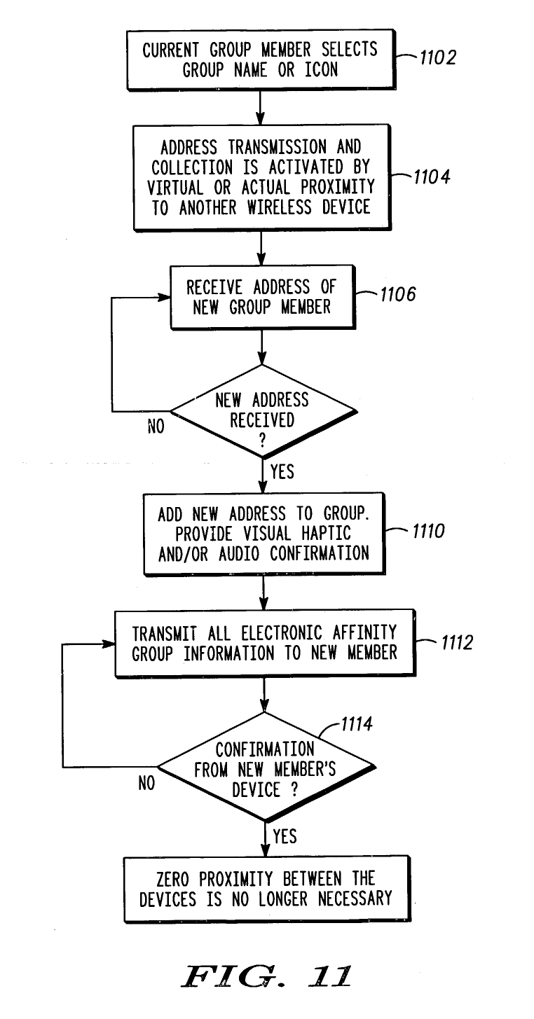

Adding a new member is illustrated in FIG. 11. In step one, a member of the ECG selects the desired ECG 1102, which has already been formed as described above. The device my be in a mode to alert the user that a new device has entered the proximity or the physical contact of the device has occurred and asked if the new devices should be added to the present group, or select a group 1104. If accepted, the device will check to see if the new address has been received 1106 and 1108, and once it has, the device provides feedback to the user 1110. The new ECG list is then transmitted to the other ECG members on the list 1112. If desired a confirmation that all ECG lists have been updated will occur at the originating device 1114. The links between the devices can be disassembled by the devices leaving proximity of one another, or manually through controls in each device. The links may also be torn down by the timing out of a timer. The ECG list may remain on each device or deleted automatically upon disassembly of link. The user may be asked to save or discard data that has been exchanged.

1. A method in a wireless communication device comprising:
sensing a second wireless communication device by a first sensor coupled to a first wireless communication device;
establishing a communication link between said first communication device and said second communication device in response to said sensing said second wireless communication device; and
transferring information between said first wireless communication device and said second wireless communication device, in response to establishing said communication link.

2. The method of claim 1,
sensing contact with a second communication device by a first sensor coupled to a first wireless communication device.

3. The method of claim 2,
sensing proximity with a second communication device by an electromagnetic, capacitive, inductive, optical, mechanical, ultrasonic, radio frequency (RF), sensor coupled to a first wireless communication device.

4. The method of claim 1,
establishing a link between said first wireless communication device and said second wireless communication device in response to sensing said second wireless communication device,
transmitting an inquiry message at least one time to said second wireless communication device;
receiving an acknowledgment message from said second wireless communication device in response to said inquiry message.

5. The method of claim 1m, establishing a link between said first communication device and said second wireless communication device in response to sensing said second wireless communication device by,
receiving an inquiry message from said second wireless communication device;
transmitting an acknowledgment message in response to receiving said inquiry message.

6. The method of claim 4, when said first communication device is not transmitting an inquiry message, said first communication device is monitoring for an inquiry message from a second wireless communication device.

7. The method of claim 1, establishing a link between said first wireless communication device and said second wireless communication device in response to sensing said second wireless communication device comprising,
transmitting an inquiry message at least one time to said second wireless communication device; and
receiving an acknowledgment message from said second wireless communication device in response to said inquiry message; or
receiving an inquiry message from said second wireless communication device; and
transmitting an acknowledgment message in response to receiving said inquiry message.

8. The method of claim 1, establishing said link by coupling a first contact point of said first wireless communication device to a second contact point of said second wireless communication device;
transmitting an inquiry message to said second wireless communication device through said first contact point and said second contact point; and
receiving an acknowledgement message from said second wireless communication device through said first contact point and said second contact point.

9. The method of claim 8, transferring data by coupling a first contact point of said first wireless communication device to a second contact point of said second wireless communication device;
transmitting data to said second wireless communication device through said first contact point and said second contact point; and
receiving data from said second wireless communication device through said first contact point and said second contact point.

10. The method of claim 1, establishing said link between said first wireless communication device and said second wireless communication device by an ad hoc network protocol.

11. The method of claim 10, wherein said ad hoc network protocol is a The Zone Routing Protocol (ZRP) for Ad Hoc Networks, Ad Hoc On Demand Distance Vector (AODV) Routing, The Dynamic Source Routing Protocol for Mobile Ad Hoc Networks, Topology Broadcast based on Reverse-Path Forwarding (TBRPF), Landmark Routing Protocol (LANMAR) for Large Scale Ad Hoc Networks, Fisheye State Routing Protocol (FSR) for Ad Hoc Networks, The Interzone Routing Protocol (IERP) for Ad Hoc Networks, The Intrazone Routing Protocol (IARP) for Ad Hoc Networks, or The Bordercast Resolution Protocol (BRP) for Ad Hoc Networks.

12. The method of claim 9, transferring data between said first wireless communication device and said second wireless communication device through said established communication link.

13. The method of claim 9, transferring data between said first wireless communication device and said second wireless communication device over at least one communication network connection.

14. The method of claim 9, wherein said contact point of said first device has a magnet and said second contact point of said second device has a magnetic field sensing switch.

15. The method of claim 13, wherein said communication network is a CDMA, GSM, TDMA, WCDMA, UMTS, Bluetooth, IrDA, 802.11 or substantially the same system.

16. The method of claim 1, receiving through said wireless link, a predefined data set, from said second wireless communication device;
storing said predefined data set to a memory of said first wireless communication device.
adding said predefined data set to a database having the same or similar data, creating an updated database.

17. The method of claim 16, sending said updated database to at least said second wireless communication device.

18. The method of claim 13, sending said updated database to a plurality of wireless communication devices, wherein said plurality of wireless communication devices are identified in said updated database.

19. The method of claim 1, receiving through a wireless link, personal contact information, from said second wireless communication device;
adding said personal contact information to a personal contact database, to create an updated personal contact database.

20 The method of claim 19, sending said updated personal contact database to at least said second wireless communication device.

21. The method of claim 15, sending said updated personal contact database to a plurality of wireless communication devices, wherein said plurality of wireless communication devices are identified in said updated personal contact database.

22. The method of claim 15,
exchanging said personal contact information such that it is added to the buddy list, phonebook, address book or other personalized list.

23. The method of claim 1, deleting said transferred information after a predetermined time has expired, or said first device has lost the established link with said second device.

24. The method of claim 1, forming a temporary ad hoc network between a plurality of device in close proximity when each device senses at least one other device.

25. A wireless communication device comprising:
a housing;
a transceiver configured to operate on at least one frequency band in communication with a wireless communication system;
a microprocessor coupled to said transceiver;
a first contact sensor coupled to said microprocessor and located at a first position on said housing
a second contact sensor coupled to said microprocessor, and located at a second position on said housing;
an ad hoc networking algorithm store in a memory of the device; and
a database operable to store information contact lists.

26. The wireless communication device of claim 25, a second transceiver coupled to said microprocessor for communication with a second wireless device at low power.

27. The wireless communication device of claim 25, a wireless communication device contact sensor.

28. The wireless communication device of claim 25, wherein said first contact sensor is a micro-switch, Hall Effect sensor, proximity sensor, inductive sensor, capacitive sensor.

29. The wireless communication device of claim 25, wherein said database is personal contact information, a buddy list.

30. The wireless communication device of claim 25, said database comprises a device ID, a user name associated with device ID.

31. The wireless communication device of claim 28, where said second contact sensor is a magnet.

32. A wireless communication device comprising:
a housing for enclosing said wireless communication device;
a transceiver configured to operate on a wireless communication system;
a microprocessor coupled to said transceiver;
a contact sensor coupled to said microprocessor for sensing contact of said wireless communication device with a second wireless communication device;
an ad hoc networking algorithm for establishing a communication link between said wireless communication device and said second wireless communication device; and
a database for storing information received from said second wireless communication device in response to said contact sensor sensing contact of said wireless communication device with said second wireless communication device.
